(19) United States
(12) Patent Application Publication
(10) Pub. No.: US 2009/0295212 A1
(43) Pub. Date: Dec. 3, 2009

(54) Armrest apparatus

(75) Inventors: Takeshi Yamane, Okayama-shi (JP); Tokuzo Kobayashi, Okayama-shi (JP); Akihiko Okamoto, Okayama-shi (JP); Kengo Tamura, Okayama-shi (JP)

Correspondence Address: Quinn Emanuel Urquhart Oliver & Hedges, LLP;Koda/Androlia, 10th Floor, 865 S. Figueroa Street, Los Angeles, CA, 90017, US

(73) Assignee: Bizen Hatsujoh Co., Ltd.

(21) Appl. No.: 12/383,514

(22) Filed: Mar. 25, 2009

(30) Foreign Application Priority Data
May 29, 2008 (JP) 2008-140827

(51) Int. Cl. A47C 7/54; B60N 2/46

(52) U.S. Cl. 297/411.32

(57) ABSTRACT

An armrest apparatus including an arm, which is fitted to a drum provided on a seat side member, and a coil spring, which is provided on the drum, wherein one end of the spring is fixed to the arm-rest member and another end of the spring, a free end, is curved outwardly in the direction away from the center axis of the drum, and this coil spring is loosely wound around the drum so as to tighten when the arm-rest member is rotated downward, and further a coil end receiving surface that receives the curved part of the coil spring is provided in the drum. When the arm-rest member is rotated downward and reaches a predetermined set angle, the coil end receiving surface receives the curved part of the coil spring, so that the coil spring tightens the drum by a downward load applied to the arm, restricting the downward rotation of the arm.

### BACKGROUND OF THE INVENTION

1. Field of the Invention

The present invention relates to an armrest apparatus installable in various types of seats including automobile seats.

2. Description of the Related Art

In armrest apparatuses, there is a mechanism that is commonly called a spring lock. In this spring lock mechanism, the inner diameter of a coil spring wound on a fixed shaft is set smaller than the outer diameter of the shaft so that the coil spring is in an always-tightened state, and thus the coil spring is able to turn freely in the backward-winding direction (loosening or unwinding direction), but in a direction that winding (tightening direction) of the spring increases, the coil spring tightens around the shaft and the rotation of the shaft is restricted by friction resistance. Japanese Patent Application Laid-Open (Kokai) No. 2004-147791, for instance, discloses this spring lock mechanism used in an automobile armrest apparatus. According to this relevant art, the advantage is that the constitution is simple; however, since the lock force is always commensurate with the friction resistance corresponding to the tightening force of the coil spring wound in a tightened state on the shaft, a contrivance is required so as not to have the coil spring slip and turn on the shaft.

More specifically, such a contrivance includes to increase the friction resistance of the spring by making the cross-section of the wire constituting the coil spring angular shape and/or by increasing the number of coiling of the wire. However, even if this contrivance is applied, when an excessive load is applied to the arm-rest member, it is not possible to prevent the arm-rest member from rotating downward. In addition, in manufacturing coil springs, it is not possible to avoid variations in the precision of the coil's inner diameter; as a result, from this point as well, a sufficient number of coiling (6 to 8 turns) is required for a coil spring; and therefore, the size of the arm-rest member tends to become larger, and the weight also tends to increase.

Meanwhile, not only is it desirable that the angle (use height) at which the downward rotation of the arm-rest member is restricted be able to freely set, but it is also necessary that the arm-rest member can be raised and housed in a seat back when it is not in use. For the convenience of such a situation, in some armrest apparatus, an angle adjustment range is provided in the bottom area of the movable range of the arm-rest member, a release mechanism is provided for releasing the spring lock at the upward limit position of this range, and a return mechanism is provided for returning to the normal tightened state at a position further beneath the lower limit position. In this system, when the angle of the arm-rest member is to be changed downward, the arm-rest member is pulled up once until it goes past the adjustment range, so that the locked state with the release mechanism is released, and then the arm-rest member is subsequently pulled down to the lower limit position and reset it with the return mechanism, and after that, the arm-rest member is pulled up to the desired angle. Obviously, this operation is cumbersome. Also, when this operation fails, it is necessary to repeat this cumbersome operation until the desired angle of the arm-rest member is obtained.

### SUMMARY OF THE INVENTION

In view of the above, according to the armrest apparatus of the present invention, which uses the spring lock effect of a coil spring with a simple constitution, a coil spring has an inner diameter that is larger than the outer diameter of a fixed shaft and is wound around the shaft in a state that the arm-rest member is able to turn freely upward and downward with respect to the drum (hereafter called a loosely-fitting state). With this structure, in the present invention, when the armrest is rotated downward to its use position, the rotation of the coil spring is restricted, and a tightening force is generated on the coil spring by the downward load provided by the arm-rest member at this time, so that the coil spring can provide a locking force. Thus, the present invention us based on an idea completely different from the conventional ideas, and the present invention is able to make the armrest apparatus lighter, make the overall size smaller and make the manufacturing cost lower.

More specifically, the present invention provides an armrest apparatus that is comprised of an arm-rest member which is fitted to a drum provided on a seat side member and is restricted at a predetermined set angle which is set with respect to a downward rotation thereof, and this armrest apparatus further comprises:
a coil spring wound around the drum so that the coil is in a loosely-fitting state to allow the arm-rest member to make both downward rotation and upward rotation and so that an inner diameter thereof decreases as the arm-rest member is rotated downward, the inner diameter of the coil spring being larger than an outer diameter of the drum, and the coil spring having at one end thereof a fixed end fixed to the arm-rest member and at another end thereof a free end formed with a curved part comprising an outwardly-extending part or an inwardly-penetrating part that extends toward a center axis of the drum, and
a coil end receiving surface formed in the drum so as to receive the curved part of the coil spring; wherein
when the arm-rest member is rotated downward and reaches the predetermined set angle, the coil spring tightens the drum by a downward load applied by the arm with the coil end receiving surface being in contact with the curved part of the coil spring, thus restricting downward rotation of the arm beyond the predetermined set angle.

Furthermore, in the armrest apparatus of the present invention, the coil end receiving surface is formed to be an inclined surface inclined with respect to the axial direction of the drum, so that with use of an operating member, the curved part of the coil spring is moved in the axial direction of the drum, allowing the predetermined set angle at which the downward rotation of the arm-rest member is restricted to be changed freely.

In addition, in the armrest apparatus of the present invention, the coil end receiving surface of the drum can be a parallel surface formed in parallel to an axial direction of the drum, so that with use of an operating member, the curved part of the coil spring is moved in a circumferential direction of the drum, allowing the predetermined set angle at which the downward rotation of the arm-rest member is restricted to be changed freely.

Furthermore, in the armrest apparatus of the present invention, the operating member for controlling the movement of the curved part of the coil spring in the circumferential direction of the drum is provided either inside or outside of the drum.

Furthermore, in the armrest apparatus of the present invention, a concave notch groove to which the curved part of the coil spring engages at an angle lower than the predetermined set angle of the arm-rest member on the drum is provided adjacent to the inclined surface of the drum.

As seen from the above, according to the present invention, the restriction of the downward turning of the coil spring, specifically, the restricting of the downward rotation of the arm-rest member when the arm-rest member reaches the set angle, can be made by a simple structure in which a curved part is formed on the free end side of the coil spring and a coil end receiving surface for receiving this curved part is formed on the drum, and thus a release mechanism and return mechanism required in the conventional armrest apparatus are not required in the present invention. In the structure of the present invention, the restriction force that restricts the downward turning of the coil spring (or the arm-rest member) is the tightening force of the coil spring which is generated when the coil spring is tightened on the entire outer surface of the drum; and when the coil spring is tightened, the free end side of the coil spring is received by the coil end receiving surface of the drum and the free end is prevented from slipping; accordingly, it is possible to counteract this with force that is applied until the wire is pulled and broken, and this restriction force is extremely strong. As a result, it is not necessary to make various considerations for the cross-sectional shape of the wire used for the coil spring, and it is also possible for the coil spring to have low number of turning (the minimum turning number for winding the entire circumference of the drum would be three (three turns)). Also, since there are no variations in the magnitude of the restriction force in terms of the dimension precision of the coil's inner diameter, production is easy, smaller size and lighter weight are possible, and productivity is excellent (lowering the cost).

Furthermore, in the structure of the armrest apparatus of the present invention, what restricts the downward rotation of the arm-rest member is the set angle that is set in advance; and above this set angle, it is possible to rotate freely upward and downward; it is, therefore, also possible to fold the arm-rest member upward and house it and to move it upward when it stands in the way, and it is possible to accurately return it to the originally set position when returning it. In addition, when the angle of the arm-rest member needs to be adjusted upon the change of the driver or upon the change in the seat position, such an angle adjustment of the arm-rest member can be made by changing the contacting point of the free end of the coil spring with respect to the coil end receiving surface of the drum. Thus, in the present invention, the changing constitution and the changing operation of the angle of the arm-rest member are simple.

### BRIEF DESCRIPTION OF THE SEVERAL VIEWS OF THE DRAWINGS

FIG. 1 is an exploded perspective view of an armrest apparatus according to the present invention;

FIG. 2 is a vertical cross-sectional view of the main part of the armrest apparatus of the present invention;

FIG. 3 is a horizontal cross-sectional view of the main part of the armrest apparatus of the present invention;

FIG. 4 is an expanded view of a drum used in the present invention;

FIG. 5 is a perspective view of the main part of the armrest apparatus of the present invention, showing an assembled state thereof;

FIG. 6 is a vertical cross-sectional view of the main part in another example of the structure of the present invention for changing the set angle of the arm-rest member; and

FIG. 7 is a cross-sectional view of the cover part in which the operating knob is installed in the present invention.

### DETAILED DESCRIPTION OF THE INVENTION

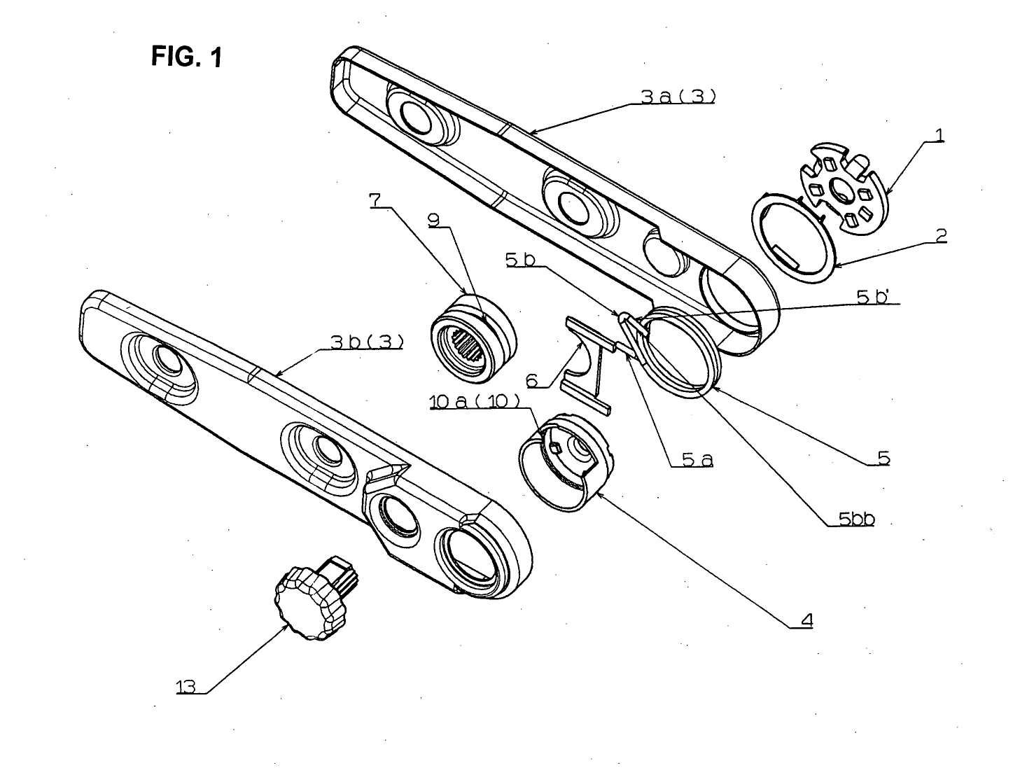

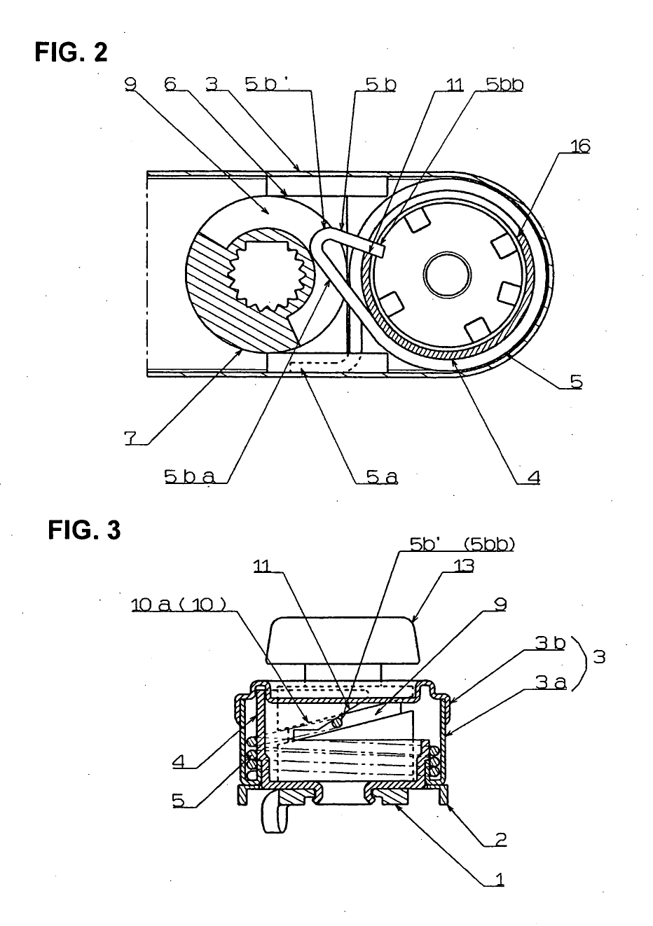

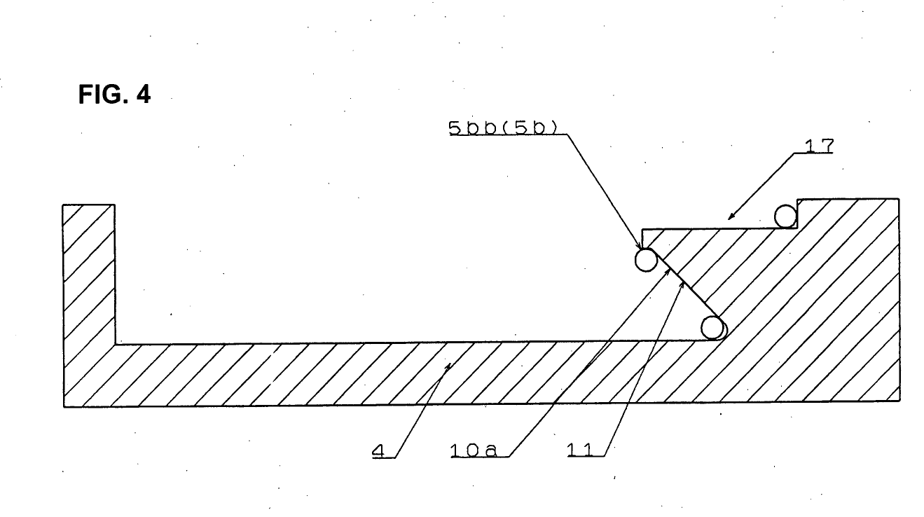

In the following, several modes for carrying out the present invention will be detailed while referring to the accompanying drawings. FIG. 1 is an exploded perspective view of the armrest apparatus of the present invention, FIG. 2 is a vertical cross-sectional view of the main part thereof, FIG. 3 is a horizontal cross-sectional view of the main part thereof, and FIG. 4 is a partial expanded view of a drum which is provided with a coil end receiving surface.

The armrest apparatus shown in these figures comprises a mounting member 1 fixed to the seat frame (not shown) of a seat of a vehicle, a washer 2, a first half arm body 3a that forms an arm-rest member 3 together with a second half arm body 3b, and a drum 4 fixed to the mounting member 1 with the washer 2 in between so that the drum 4 is not rotatable. Furthermore, a coil spring 5 is wound around in a loosely-fitting state on the drum 4 so that it tightens when the arm-rest member 3 is rotated downward. The coil spring 5 has a fixed end 5a at one end thereof and a free end 5b at anther end thereof, and the fixed end 5a is fixed to the first half arm body 3a. The armrest apparatus further includes, among others, a cover or a second half art body 3b that mates with the first half arm body 3a to form the arm-rest member 3 as described above, a reinforcing member 6 attached to the arm-rest member 3, an operating member 7 that works on the free end 5b of the coil spring 5, and an operating knob 13 that works with the operating member 7.

These components are assembled in sequence to form an armrest structure; and when this structure is covered with a surface skin, stuffed with a cushioning material attached to the seat frame, the armrest apparatus is completed.

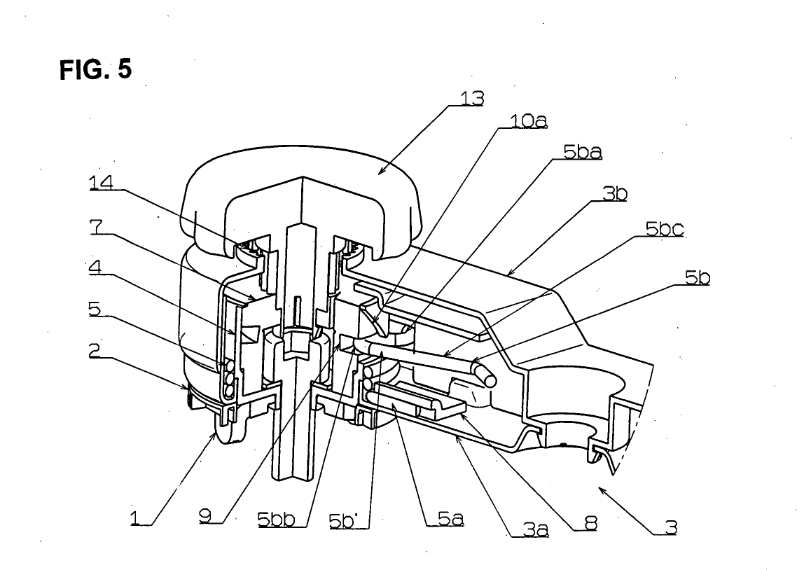

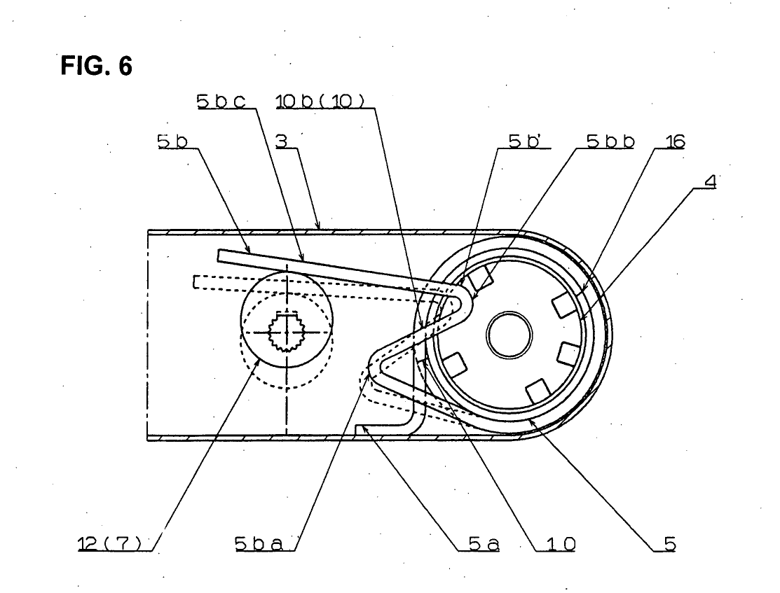

In the above-described structure, the fixed end 5a of the coil spring 5 is fixed to the first half arm body 3a by the pressing part 8 (see FIG. 5), and the free end 5b of the coil 5 is, as best seen from FIG. 2, formed with a first outwardly-extending part 5ba that extends out away from the drum 4 and an inwardly-penetrating part 5bb that curves from the end of the first outwardly-extending part 5ba and extend into the drum toward the center axis thereof. The first outwardly-extending part 5ba and the inwardly-penetrating part 5bb are collectively called a curved part 5b′ that is comprised of the outwardly and inwardly curved portions. In this structure, it is preferable that the inwardly-penetrating part 5bb penetrate into the drum 4 at an angle close to the right angles so that slippage thereof can be avoided.

The operating member 7 of the shown example (first example) is a sleeve that is rotatable in parallel to the axis of the drum 4 and is provided on the first half arm body 3a so that it is located on the tip end side of the arm body 3a and is separated from the drum 4. The operating member 7 is formed with a spiral groove 9 on its outer circumference surface, and the curved part which is located between the first outwardly-extending part 5ba and the inwardly-penetrating part 5bb of the coil spring 5 is engaged with this spiral groove 9.

Furthermore, a coil end receiving surface 10 that receives the tip end of the inwardly-penetrating part 5bb of the coil spring 5 is formed in the drum 4. The coil end receiving surface 10 in the shown (first) example is an inclined surface 10a that is inclined in the axial direction of the drum and formed directly on a part of the drum 4 (see FIG. 4). With this coil end receiving surface 10 (10a), when the operating member 7 is turned by the operation of the operating knob 13, the inwardly-penetrating part 5bb of the coil spring 5 is moved in the axial direction of the drum 4 along the inclined coil end receiving surface 10a since the curved part which is located between the first outwardly-extending part 5ba and inwardly-penetrating part 5bb of the coil spring 5 is engaged with the spiral groove 9 of the operating member 7. When the inwardly-penetrating part 5bb is thus moved in the axial direction, the point (this is called receiving part 11) on the coil end receiving surface 10 that receives the inwardly-penetrating part 5bb changes in the circumferential direction of the drum 4, and as a result the angle that restricts the downward rotation of the arm-rest member 3 (this is called a “set angle”) is changed, making it possible to change the set angle. The coil end receiving surface 10 is not necessarily formed directly on the drum, and it is possible to fix a separate member that is formed with an inclined coil end receiving surface 10a to the drum 4.

When a downward load is applied to the arm-rest member 3 at the set angle, the coil spring 5 and the drum 4 change from a loosely-fitting state to a tightened state, and the above-described spring lock force is generated, restricting the downward rotation of the arm-rest member 3. In addition, a reaction force of the force by which the wire is pulled is added as a locking or tightening force; and this reaction force corresponds to the size of the downward load and it is possible, as noted above, to output the reaction force to the maximum limit of the full wire tensile strength. Accordingly, the locking force provided by these aggregated force is very strong (and there is no slipping even when an excessive load is applied). Meanwhile, at a set angle that is set by the rotation of the operating member 7 caused by rotating the operation knob 13, the spring lock force is generated; accordingly, the load applied (distributed) to the receiving part 11 of the drum is small, and the strength of that part is not required to be very high. Also, since the free end 5b of the coil spring 5 is engaged with the spiral groove 9 of the operating member 7 and the axial direction movement of the free end 5b is thus restricted, even when the angle of incline of the inclined surface 10a on the drum 4 is as steep as about 45°, no slipping of the coil spring 5 occurs.

In the above-described structure, the coil inner diameter of the coil spring 5 is greater than the outer diameter of the drum 4 so that the coil spring 5 is in a loosely-fitting state on the drum 4. The “loosely-fitting state” here means that it is possible for the coil spring 5 to turn freely on the drum 4 in the direction of increasing the winding; and as long as this is ensured, it is acceptable for the coil spring 5 to have the coil inner diameter which is the same as or, in some cases, somewhat smaller than the outer diameter of the drum 4. When the inner diameter of the coil spring 5 is excessively greater than the outer diameter of the drum 4, though the turning force on the coil spring can be small, there is a greater looseness from the point where the arm-rest member 3 reaches the set angle till the point where the downward rotation is restricted, and the operational feel is decreased.

FIG. 6 is a vertical cross-sectional view of the main part of another example (second example) of the armrest apparatus of the present invention for changing the set angle of the arm-rest member 3.

In the structure of FIG. 6, yet another, second outwardly-extending part 5bc is formed at the tip end of the inwardly-penetrating part 5bb of the free end 5b of the coil spring 5 so that the second outwardly-extending part 5bc extends outwardly from the curved part 5b′ of the inwardly-penetrating part 5bb. In addition, instead of the inclined surface 10a described above and shown in FIG. 4, a parallel surface 10b that is parallel to the axial direction (or center axis) of the drum is formed in the drum 4, and the operating member 7 is provided with an eccentric cam 12 that acts on the second outwardly-extending part 5bc of the coil spring 5. With this structure, when the operating member 7 is turned, the mode (or position) of extension of the second outwardly-extending part 5bc (and the inwardly-penetrating part 5bb as well) changes as indicated by dotted lines in FIG. 6, and as a result, the position of inwardly-penetrating part 5bb of the coil spring 5 with respect to the receiving part 11 changes in the circumferential direction of the drum, so that it is possible to change the set angle of the arm-rest member 3.

In the above-described structure, a groove (not illustrated) can be formed in the outer circumference surface of the eccentric cam 12 on which the second outwardly-extending part 5bc of the coil spring 5 acts, so that the second outwardly-extending part 5bc is brought into this groove. This structure can prevent the second outwardly-extending part 5bc from skewing in the axial direction of the eccentric cam 12, which is preferable.

As described above, in both of the examples described above, the construction for allowing the set angle of the arm-rest member 3 to be changed is simple, and the operation for changing it is also simple. More specifically, in terms of the structure, it is sufficient to simply form a coil end receiving surface 10 on the drum 4, and neither a complex release mechanism for releasing the tightening of the coil spring 5 nor a return mechanism for this is required. In addition, since the coil spring 5 and the drum 4 are in a loosely-fitting state, mounting the spring 5 on the drum 4 can be done easily. Furthermore, regarding the operation, it is possible to freely adjust the arm-rest member 3 up and down; and the troublesome operation of pulling the arm-rest member 3 up to the top limit position once and then pulling it down to the downward limit position, and then lifting it up to the specified angle is not required. In case there is failure with this angle setting, the bothersome operation of having to re-do the operation again is not required in the present invention.

In the examples described above, the operating member 7 and the operating knob 13 are provided away from the drum so that they are respectively at an offset position toward the tip end of the arm-rest member. This arrangement makes the operation in a seated state easy. Also, in this offset arrangement or in the structure that the operating member 7 and the operating knob 13 are not provided coaxially with the drum, there is also such an advantage that the operating member 7 is prevented from turning synchronously by being affected by the rotation operation of the arm-rest member 3. However, it is also possible to provide a coaxial structure for these elements, which gives a simple outer appearance. FIG. 5 is a perspective view of the main part of such a structure. In other words, it is only necessary to assemble the operating member 7 and the operating knob 13 on the cover 3b and insert them into the drum 4; and in this case, engagement relationship between the free end 5b of the coil spring 5 and the spiral groove 9 or eccentric cam 12 can be the same as that of the first example.

Also, though not shown in the drawings, it is also possible to provide the operating member 7 and the operating knob 13 on the drum 4. In this structure, as the arm-rest member 3 is operated, the free end 5b of the coil spring 5 slides in the spiral groove 9 of the operating member 7 each time the arm-rest member is moved, and the movement of the free end 5b in the axial direction is repeated. In this structure, further, with a selection of resin or the like for the material of the operating member 7, the free end 5b of the coil spring 5 can slide smoothly. In any event, the angle setting and the spring lock generating mechanism are basically the same as in the described examples, and the fact that a wire tensile strength is added corresponding to the reaction force of the downward load applied to the arm-rest member 3 at the set angle is also the same, and thus the present invention provides an efficient construction for an armrest apparatus.

Furthermore, in the above-described examples, the inclined surface 10a or the parallel surface 10b are formed as an integrated element to the drum 4. However, it is also possible to provide such surfaces on a separate member and attach such a separate member having such surfaces to the drum 4. In this case, though the number of parts required increases, the advantage is that it is possible to change the position of such surfaces and to select preferred material thereof.

In the present invention, the curve shape of the curved part 5b′ of the coil 5, the position and shape of the spiral groove 9 and the eccentric cam 12, the position and manner with which the curved part 5b′ contacts the spiral groove 9 and the eccentric cam 12, the shape of the coil spring 5, and the shape and function of the operating member 7 can be suitably selected. In addition, though the operating member 7 described above is operated rotationally, it is also possible to design so that the arm-rest member 3 slides in the width direction or the lengthwise direction of the arm-rest member 3.

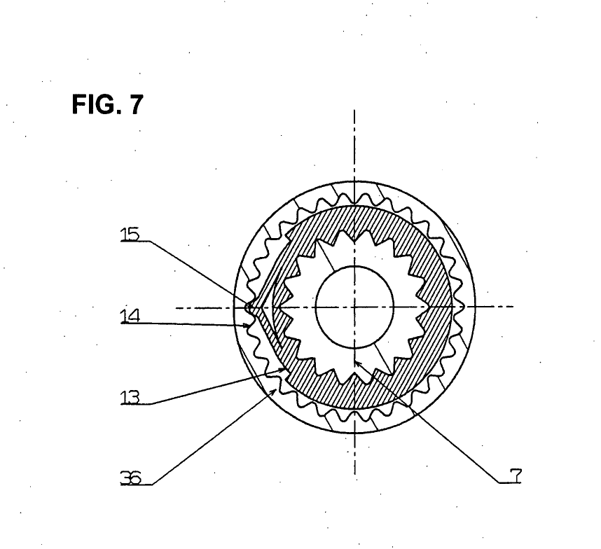

In addition, in both of the above-described examples, the rotated angle of the operating member 7 shall not be changed by the load or oscillation or the like applied from the free end 5b side. FIG. 7 is a cross-sectional view of the main part showing an example that can prevent the angle change in the operating member.

In this structure, the operating member 7 is connected to the operating knob 13 by a spline engagement or the like so that the operating member 7 is operated by the operating knob 13 that is provided outside of the cover 3b; and an internal gear wave 14 is formed in the insertion opening formed in the cover 3b so that the operating knob 13 is inserted in this insertion opening, and an elastic projection 15 is formed on the outer circumference of the operating knob 13 so that the projection 15 elastically engages with one of the recess of the internal gear wave 14.

In this structure, the operating member 7 can take that the load or oscillation from the free end 5b side; and when the operating knob 13 is turned and each time the position with respect to the internal gear wave 14 is changed, a sound similar to a dial tone is output, providing a good operational feel. In addition, it is also possible to add a fixed resistance to the rotation of the operating member 7 (operating knob 13) by which the rotation will not occur at the level of the load from the free end 5b side. The advantage of this structure is that it is possible to set the angle of the operating knob 13 without gradations. In this case, it is convenient to provide a scale or the like on, for example, the operating knob 13 corresponding to the set angle of the arm-rest member 3.

In addition, in the above-described examples, at both the upward position and the downward position of the arm-rest member 3, the rotation of the arm-rest member 3 is restricted by stoppers at the limit points. The lowest point of the inclined surface 10a (in the case of the first example) can constitute the downward limit stopper, and a notched surface 16 (see FIGS. 2 and 6) which is a cut made in the axial direction formed in the drum 4 can make the upward limit stopper. As to this upward limit stopper, when the free end 5b of the coil spring 5 comes into contact with this notched surface 16, the upward rotation beyond that point is restricted.

A reclining mechanism is generally installed in the seat of automobiles so that the seat back is pushed down to substantially a horizontal level; and when the seat is reclined, the arm-rest member is also generally set to a reclining position which is a position raised about 30° from the horizontal level.

Accordingly, it is necessary for the arm-rest member 3 to be able to change the position to such a reclining position as well. For this positional change, a receiving part that allows the arm-rest member to be at an even lower angle than the minimum angle is required to be formed on the inclined surface 10a (typically this is about 90° to the seat back) so that the reclining position of the arm-rest member 3 is set at this position where the free end 5b of the coil spring 5 reaches the receiving part. This receiving part can be anywhere on the inclined surface 10a in the drum. However, if the spiral groove 9 and the curved part 5b′ are set away from each other, there would be cases that the inwardly-penetrating part 5bb is unexpectedly moved due to the impact against the receiving part. There would be also cases that the inwardly-penetrating part 5bb is unexpectedly moved due to a large oscillation. Since these movements are downward slide along the inclined surface 10a, when the receiving part is provided adjacent to the arm's minimum angle, a sudden shift of the arm-rest member to the reclining position would occur due to such unexpected movements. This kind of movements is dangerous for the passenger. Accordingly, in the present invention, the following structure is employed.

More specifically, as shown in FIG. 4, a concave notch groove 17 in which the inwardly-penetrating part 5bb of the coil spring 5 is engaged is formed with a space left open adjacent to the point corresponding to the maximum angle of the upward rotation of the arm-rest member 3 on the inclined surface 10a, and the bottom of this concave notch groove 17 is provided even lower than the lowest point of the inclined surface 10a so as to be used as the above-described receiving part. In this structure, when putting the arm-rest member 3 in the reclining position, this would go past the maximum angle of the arm; and thus when there is such an unexpected movement as noted above, there is only a slight movement downward, and there would not be a sudden shift of the arm-rest member to the reclining position.

In addition, in the above structure, a slight step can be formed next to the maximum angle position so that there is a feeling of a certain degree of resistance when operating beyond the maximum angle. This is desirable in terms of preventing faulty operation.

The above description of the present invention is made for an armrest apparatus. However, the present invention is not limited to this and is applicable to other purposes. More specifically, the present invention is applicable to, for example, the back resting surface or sitting surface of a seat or chair in which though the angle of a load receiving surface is adjustable, a unidirectional movement is restricted.

1. An armrest apparatus comprising an arm-rest member which is fitted to a drum provided on a seat side member and is restricted at a predetermined set angle which is set with respect to a downward rotation thereof, the armrest apparatus further comprising:
a coil spring wound around said drum so that said coil is in a loosely-fitting state to allow said arm-rest member to make downward rotation and upward rotation and so that an inner diameter thereof decreases as said arm-rest member is rotated downward, said inner diameter of said coil spring being larger than an outer diameter of said drum, and said coil spring having at one end thereof a fixed end fixed to said arm-rest member and at another end thereof a free end formed with a curved part comprising an outwardly-extending part or an inwardly-penetrating part that extends toward a center axis of said drum, and
a coil end receiving surface formed in said drum so as to receive said curved part of said coil spring; wherein
when said arm-rest member is rotated downward and reaches said predetermined set angle, said coil spring tightens said drum by a downward load applied by said arm with said coil end receiving surface being in contact with said curved part of said coil spring, thus restricting downward rotation of said arm beyond said predetermined set angle.

2. The armrest apparatus according to claim 1, wherein said coil end receiving surface is formed to be an inclined surface inclined with respect to an axial direction of said drum, so that with use of an operating member, said curved part of said coil spring is moved in the axial direction of said drum, allowing said predetermined set angle at which said downward rotation of said arm-rest member is restricted to be changed.

3. The armrest apparatus according to claim 1, wherein said coil end receiving surface of said drum is a parallel surface formed in parallel to an axial direction of said drum, so that with use of an operating member, said curved part of said coil spring is moved in a circumferential direction of said drum, allowing said predetermined set angle at which said downward rotation of said arm-rest member is restricted to be changed.

4. The armrest apparatus according to claim 2, wherein said operating member for controlling a movement of said curved part of said coil spring in said axial direction of said drum is provided one of inside and outside of said drum.

5. The armrest apparatus according to claim 3, wherein said operating member for controlling a movement of said curved part of said coil spring in said circumferential direction of said drum is provided one of inside and outside of said drum.

6. The armrest apparatus according to claim 2, wherein a concave notch groove to which said curved part of said coil spring engages at an angle lower than said predetermined set angle of said arm-rest member on said drum is provided adjacent to said inclined surface of said drum.
